(19) United States
(12) Patent Application Publication
(10) Pub. No.: US 2007/0034226 A1
(43) Pub. Date: Feb. 15, 2007

(54) Combination food spearing apparatus and toothpick comprising integral granular and liquid spice containment and dispersal means and method

(76) Inventor: Steven Michael Ferkel, Auburn Hills, MI (US)

Correspondence Address: Steven Michael Ferkel, 2549 Genes, Auburn Hills, MI, 48326, US

(21) Appl. No.: 11/203,629

(22) Filed: Aug. 15, 2005

(51) Int. Cl. A61C 15/00

(52) U.S. Cl. 132/329

(57) ABSTRACT

A compact and disposable food flavoring container and dispenser utilizing its integral food stabbing feature for its delivery with fruits or vegetables accompanying an alcoholic beverage. Device also may be stabbed into and delivered with other consumable products which are enjoyed with additional spices or flavorings. Devices food stabbing means may further be utilized to clean lodged food material from between a persons teeth and gums. This device is preferably a cylindrical, elongated and shelled plastic structure having a hollowed out chamber which stores a single serving of dry granular spice or low viscosity fluid spice or flavoring with its dispensing spout created upon the breaking or tearing open of its integral member by its operator.

### FIELD OF INVENTION

This invention relates to food picks and food stabbing devices which are used to skewer an article of food for its delivery with an alcoholic beverage as well as toothpicks having storage facilities within their architecture.

### BACKGROUND OF INVENTION

Traditionally, toothpicks are small, elongated, rigid, solid apparatuses about three inches in length and roughly ⅛″ in diameter. Most toothpicks are tapered to an elongated, gradual point at each of their ends.

A toothpick is traditionally and primarily used to clean the teeth of a person who has food stuck between them. Toothpicks are primarily made from wood although there has been some made out of plastic and some have even been integrated with single use dental floss. In my research I have found that many toothpicks have been integrated with different utilitarian shapes, angles, materials, storage means, dispensing means, architectural structures, and many have been published in patents with many different claimed utilities and modes of operation. Some toothpicks have been integrated with gum massagers, removable and changeable picking ends, and some have even been made of porous materials which can absorb nicotine which can be dispersed to a person in the periphery of their mouth when said toothpick is salivated on and sucked on. Toothpicks have been used to check the centers of baked foods as well as help detect spoiled foods. Many different design patents have bee published exhibiting various ornamental elements which, under examination, do give a better understanding of the popularity and number of different embodiments for the toothpick. Toothpicks are sold in stores in bulk packages of 100+ count and some are even individually wrapped in sealed plastic or paper packages for sanitary public distribution out of a serving dish or bowl.

What has occurred to me, is an absence of innovations and inventive means in the construction of food stabbing toothpicks and cocktail picks used in the food and beverage industry. Out of necessity I have invented a better food stabbing apparatus and granular spice storage and delivery means for the consumption of a straight serving of tequila which will also aid in the preparation, serving, and consumption of various other cocktails which require additional condiments or accompaniments. My new invention utilizes a multitude of structural elements that when combined into my new embodiment form a completely new invention with a new utility and mode of operation. I have invented a new device and means to prepare, deliver, and consume a straight serving of tequila using the traditional wedge of lemon or lime as well as a single serving of kosher salt in an easy to handle, easy to deliver, easy to store embodiment which exhibits added sanitary protection of the salt and fruit. My invention also provides increased handle ability in the retrieval of both the fruit and salt from the periphery of my invention as well as the invention as a whole from the periphery of a beverages container which my invention may be placed in prior to its delivery to the consumer. Although this new invention has many utilities, tooth picking is just one of several utilities and because the primary utility of my invention is to aid both the person who prepares the beverage as well as the consumer of said beverage in a quick and easy manner without sacrificing any of the traditional aspects, it provides a more hassle free method for consuming a shot of tequila in a public or private surrounding first and foremost. It should be understood that this new invention has a food stabbing feature which can also double as a tooth pick and should not be interpreted as just a toothpick and is not necessarily to be interpreted as a toothpick as is known in the prior art. My invention is to be utilized primarily in a bar /restaurant establishment improving the preparation, delivery, and consumption of a straight servings of tequila as well as other servings of various foods and beverages.

It is my observation that there are many ways to monopolize on the fundamental object of an elongated and pointed object like a toothpick or cocktail pick. Due to the fact that my invention is an elongated, pointed structure having the same utilities as both a cocktail pick and toothpick I believe that their integration into my inventions structure to be secondary in its importance in some cases of my inventions use and of primary importance in other cases of my inventions use. If I were to specify my new invention as a toothpick I would state that this invention is a ground or liquid flavor dispensing toothpick with added innovative improvements in its construction, architecture, mode of operation and utility while not sacrificing any of the toothpicks attributes such as, but not limited to, its ease of handling; disposable nature, rigid structure, and over all compact storage ability. If I had to describe this invention as a cocktail pick it would be described as an elongated food spearing apparatus which doubles as a toothpick having a spice storage and dispersal means integral. If I were to describe it as an aid for doing a shot of tequila I would put emphasis on its salt storage and delivery capabilities as well as its fruit wedge delivery, retrieval, and consumption benefits which just happen to have the added benefit of being the perfect shape and size for the removal of fruit pulp between a persons teeth and gums as well as for the spearing and skewering of articles of food for their delivery to the consumer.

Most specifically and preferably, this inventions overall object is to provide a better means of delivering a single serving of sterile spice and or flavoring with an alcoholic beverage in an inexpensive, disposable, easy to store and handle embodiment coinciding with a fruit wedge delivery and retrieval means which is also to be used in the removal of food articles from between the teeth and gums of the consumer.

It is obvious, with the vast number of similar, yet distinguishable, inventions like toothpicks and cocktail picks, that many inventions in the field comprise specific attributes and elements which have not previously been combined and integrated into the new, single, preferred embodiment of my invention therefore it is my goal and objective to disclose the prior arts of these inventive elements of different inventions which do, when combined together, form my new invention providing new inventive means, utility, mode of operation and structure by such a combining and integration of said elements. Although some of these elements may seem obvious while examined separately and in their current embodiments, it should be understood that these separate elements of different inventions, when combined and joined integrally, do form my new invention, and without disclosure of such a combination, integration, specified use or mode of operation obviousness is not determinable do to the fact that no such combination of these elements nor description of their mode of operation or utility has been publicly disclosed or published in any letters of patent and I believe such a combination does provide added benefit and utility worthy of patent protection.

Due to the large field which this invention covers and the multitude of findings which have been published and known in the art, I will make a comparison and description as to the closest patents I have found in my search that I find relative to the art with references and comparisons made to my invention as well as those that may comprise similar elements with different structural means, modes of operation, and utilities. These primary references, of the multiple references cited, are mentioned and compared by myself to better aid the patent examiner in understanding what I am claiming in the claims section of this patent application.

It is my strong opinion that my invention is, from the stand point of the known and prior art, a new and patent able embodiment, and structure, having a different and new mode of operation than that of the prior art. My invention is designed preferably for delivering spice of a granular nature to the consumer of a straight serving of tequila, specified substance dispersal means coinciding with integral fruit slice delivery and retrieval device. Said fruit delivery and retrieval device is constructed from a unitary, shelled plastic structure, hollowed out preferably throughout a thin elongated embodiment forming integrally a sealed food stabbing device and ground spice storage compartment which also may be utilized by the user of said invention for the removal of fruit pulp lodged between their teeth and gums by its food piercing, elongated and tapered end.

My invention provides improvement in its ergonomic handle ability and overall utility of being a ground or granular spice dispenser integral with a food spearing apparatus. My inventions has the utility of a food spearing device containing a single serving of ground or granular spice to be place able and retrievable from the inside periphery of a cocktail and more specifically a container containing a straight serving of tequila. Under close examination of the preceding patents, it is my opinion that my invention is innovative and new. From what I have found in my search, my invention does not trespass or take away from any prior claims and it is not, in any way, my intention, to make statements that are derogatory but rather to differentiate the facts which separate their spirit and scope from my spirit and scope.

Under close examination of U.S. Pat. No. 4,805,646, I have come to the opinion that this prior inventions object and utility are different from my invention, which does resemble said patent but only in the aspects and perceptions that can be concluded from acknowledgement and understanding of the prior art of tooth picking apparatuses, more specifically, those that have integral, shelled, internal compartments with the object of delivering their stored material upon demand or necessity. Acknowledging the prior and known art, I can only come to the conclusion that U.S. Pat. No. 4,805,646 is new and distinct from the prior art in its utility of being a toothpick having added structural means for achieving angular manipulation of its architecture by elbowing axis's along its elongated sidewalls with its applicator end acting as the tooth picking portion. It is further a new inventive means and utility for a toothpick that disperses its content the squeezing of formed and filled bellows to achieve substance displacement, distribution and application.

In trying to convey the differences between invention U.S. Pat. No. 4,805,646 and my invention, due to the fact that they are both tooth picking apparatuses with substance storage and dispersal means, I have made note of their similarities and they are as follows:

a) Both of our inventions have tooth picking means integral.

b) Both of our inventions have integral, shelled storage areas in their central peripheries.

c) Both of our inventions are made of plastic.

d) Both of our inventions are elongated and preferably tubular.

e) Both of our inventions are made to be disposable.

To better convey the differences between my invention and that of U.S. Pat. No. 4,805,646, I have noted the said differences and they are as follows:

a) My invention can dispense both granular substance as well as low viscosity fluid substance as where the prior invention is intended to dispense high viscosity liquid, paste, or syrup substances.

b) My invention does not use architectural means of displacing or ejecting its substance but rather relies on gravitational force for dispersion of its contents from its shelled housing, in a pouring manner, after it has been opened by an innovative ergonomic structural arrangement.

c) My invention is structurally designed to be unbendable and narrow along its elongated embodiment making my invention more ideal for food stabbing utility where as the prior invention is flexible and not intended to be utilized as a food article piercing apparatus.

d) My invention is structurally designed to provide more instant access to ground spice to be enjoyed with an article of food as well as offer a different means of delivering said spices to the consumer of said food where as the prior inventions object is not to be stabbed into food or used as a ground spice delivery means.

e) My invention is further designed structurally to be utilized as a food article retriever, retrieving a wedge of fruit from a cocktail glass while concurrently offering a ground spice from same food stabbing apparatus where as the prior invention makes no claim or suggestion of such a utility.

f) My invention is preferably to be used in the preparation, serving, and consumption of an alcoholic beverage as where the prior invention makes no such claim or suggestion of utility.

Although it is clear to me that substance dispersing toothpicks have been around since 1903, under examination of patents (U.S. Pat. Nos. 7,19,017), and (3,672,378), it is clear to me that U.S. Pat. No. 4,805,646 claims priority as a device using structural advantage for angular manipulation and bellowing means for substance displacement while further exhibiting angular change ability means which gives the user a greater degree of handle ability in its operation as a toothpick however, it does not claim soul priority as a toothpick having substance storage and dispersal means comprised integrally.

The dispensing substance of U.S. Pat. No. 408,646 was clearly stated as having a gel, syrup, or paste consistency and by further examination of claim 1 it appears to me to be the intended and preferred substance of the inventor for his invention. I have also found that the inventor made no mention of how his invention would handle such a granular or ground solid substance nor did he disclose any suggestive uses for his innovation in the serving of straight tequila which is the preferred object of my invention. The new art of U.S. Pat. No. 4,805,464 is obviously constructed with squeezable means for displacement of its substance from its shelled structure while my invention works on gravity aided dispersion much like a salt or pepper dispenser. It should be further noted that invention U.S. Pat. No. 4,805,646 is primarily conveyed and described as being an applicator which delivers a high viscosity liquid syrup or gel like a miniature squeezable substance displacement applicator used by many adhesive manufactures and departs further from my invention in that fact.

Though my invention is a substance dispersing device, its object is to be defined as a structural embodiment which can store and disperse both low viscosity liquid as well as solid, granular, substance. It is further defined as dispersing its substance with the aid of gravitational force and possibly shaking and tapping of its handle able, elongated housing which is a compact, pre sealed housing with easy ergonomic break open means.

My new invention is further defined as comprising an integral food stabbing structure which aids in the delivery and retrieval of said substance by it being attached to an article of food by stabbing means prior to its delivery to the consumer.

It is further the object of my invention to be structurally unbendable for its utility of being a food article stabbing apparatus aiding in the production, presentation, and consumption of an alcoholic beverage and could even be further utilized in the food serving industry as an alternative delivery means for salts peppers and various other condiments like Tabasco sauce, or liquid spice of low fluid viscosity.

It is further the object of my invention to be especially rigid and elongated in its structure as to allow an increased ergonomic advantage in the opening of devices snap open, dispersal end, utilizing and taking advantage of leverage and single hand biomechanics for its operation. The specified unbendable structure of my device also has the object of making possible the piercing of dense food objects such as a lemon or limes outer skin without its side walls collapsing and folding over upon heavy pressure being applied, in a downward direction, in such an operation.

It is further the object of this invention is to provide more readily available access to a sterile spice or condiment within the structure of a disposable tooth pick or cocktail pick, said pick placed preferably in the inside periphery of a beverage container in a longitudinal direction, tapered end pointing down.

It is further the object of this invention to provide more stable handle ability in the stabbing of dense articles of food while simultaneously providing more immediate means to clean between a persons teeth and gums by same handle able device which is also a substance storage and dispersal mechanism.

It is yet further the object of this invention to offer to food or drink servers a serving aid having multiple utilities all operate able from one single easy to deliver, easy to store, easy to retrieve, easy to dispose, shelled embodiment.

Under close examination of U.S. Pat. No. 6,398,063, which is a sanitary beverage serving device, it has occurred to me that its structural embodiment is unlike mine as well as its mode of operation. Under further examination of this patent I have found that its embodiment is not a break open spice containment and dispersion apparatus nor does it offer sealed, sanitary enclosure for the sanitary delivery of said spice, but rather offers itself as a surface to which salt can be placed upon prior to its delivery to the consumer upon a glasses rim. Under yet further investigation and study of this patent I have further concluded that it is designed specifically to avoid contact with the beverages contents as where my invention embraces such contact with a beverages contents and is specifically designed to be water resistant and sealed to keep its contents from becoming mixed or contaminated by an alcoholic beverage such as, but not limited to, a straight serving of poured tequila. While further reviewing U.S. Pat. No. 6,398,063, it is clear to me that it is not the inventions object to remove fruit pulp from between a persons teeth and gum area, designed structurally to retrieve a slice of fruit from the bottom portion of a containers inside periphery, nor is it constructed to be placed within the inside periphery of a beverage container which my invention is. This invention does offer a means of attachment to a beverage containers rim, as does mine, but its attachment means and structure is different from mine in the fact that it is an integral, structural embodiment which holds its accompaniments above and outside the periphery of the containers insides. Further, it should be stated, that this inventions attachment portion is integral and necessary for its utility and function as where mine is an optional structural embodiment and an attachment for presentation and partial stabilization purposes and is not necessary for the claimed utility and method of the preferred embodiment of FIG. 1 of the several drawings. My rim attachment means and method of use further separates itself from the invention of U.S. Pat. No. 6,398,063, in the fact that it is primarily attached to my preferred embodiment for added advertisement or nutritional fact information print area real-estate and gives better presentation means if my invention is served with a very expensive tequila in an atmosphere which demands added attention and detail in its serving practices.

It should be noted that this inventions spirit was conceived from and by the necessity for a better salt and lime delivery means in both the serving and consumption of the one of a kind, straight serving of tequila and while working on prototypes and different methods of use for this invention I have discovered that the scope and spirit of this invention may not be limited to the serving of tequila but might also include other food serving practices and applications without departing from the true spirit and scope of what is claimed and described by myself in this application.

### BRIEF SUMMERY OF INVENTION

The well known use for a toothpick, which is cleaning out excess food lodged between a persons teeth and gums, is combinable, by structural means, with an integral storage and distribution means for dispensing a single portion of granular salt which is to be consumed with a straight serving of tequila, invention offering better and more instant ergonomic access to a single serving of salt or other spice while concurrently providing tooth picking means for the removal of pulp or article of food consumed with said serving of tequila from between the users teeth and gums.

My invention is a total redesign of the toothpick as it is known, integrated with a shelled, break or tear open, spice storage container, my toothpick comprises an integral spice dispensing means which provides storage capacity maximization for both the toothpick and the spice which said toothpick temporarily stores.

This invention is a single, integral, shelled and break open able apparatus which stores a single serving of spice or flavoring within a compact, sealed, water resistant container, structurally integrated with a tooth picking, also food stabbing, portion for maintaining personal oral hygiene as well providing intended food stabbing means of an article of food which is served with a cocktail or beverage, said apparatus attachable to, by piercing means, a wedge or slice of fruit either prior to it being served or after it has been delivered along with said cocktail or beverage.

Constructed preferably from plastic, this invention can be made by hand or mass produced by injection plastic molding techniques in a plant environment.

### DETAILED DESCRIPTION

FIG. 1 of the several drawings shows a plastic, shelled embodiment having two sealed ends A and B. Under inventions construction, using cylindrical plastic tubing, end A is heated to a pliable melting point and then stretched and press formed into its enclosed, tapered, pointed, toothpick and food stabbing arrangement. Once invention is in this hollowed out toothpick embodiment, with its opposite end B still open, granular or liquid spice flavoring is added to its hollowed out central section C. End B is then formed by the sealing together of its inner side walls with glue or melted plastic, in the periphery of its end B, after it has been loaded with its spice or flavoring, completely sealing in the spice within the elongated shelled embodiment of toothpick formed.

After the elongated embodiment of invention is sealed, cooled, and containing its spice it is then rolled on its elongated, tubular sides upon a stable, planar, base material while opposite side of said base is rigged with a razor blade which applies pressure to the elongated side walls of shelled structure as it is rolling sandwiched between the blade and said base, blade making contact with said elongated side walls, cutting a 280 degree circular relief cut around the elongated side walls of shelled structure without completely cutting through. When the elongated plastic shell is rolled in an even perpendicular direction the blade slices into the shelled inventions side walls to a depth of at least 80% of the thickness of inventions side wall material causing a breakable relief hinge cut in a line continuing and forming a 280 degree radial cut into its elongated side walls nearer to end b. Said shell 1 is elongated in its configuration to be handle able as a toothpick, deli sandwich pick, or fruit pick with the combined utility of being a water proof, sealed, spice dispenser which is snapped and broken open upon demand.

The invention retains its integrity as a toothpick due to its rigid and elongated structuring which is calculated by factoring in the intention of keeping the toothpick relatively un break open able when being handled as a toothpick or used as a food stabbing or piercing device, yet easy to open with pressure applied to its side walls in the periphery of end b by the operators thumb while being grasped and held firmly near its central portion C and end A by the operators fingers, palm, and thumb.

FIG. 1 of the several drawings shows the preferred embodiment for my invention. It shows the unit as a single piece of plastic, elongated and hollowed out in its central section C, exhibiting a relief cut D into its side walls in the periphery of end B . Shelled toothpick of FIG. 1 showing tapered end A, end B, center storage periphery C, and relief hinge cut D as one integral sealed unit without sticker or advertisement attachment.

FIG. 2 of the several drawings shows an isometric view of inventions preferred embodiment integrated with a sticker tag.

FIG. 3 is a modified form of my invention constructed from two separate components, the elongated, break open able, shelled and preferred embodiment of FIG. 1 and 2 with the addition of a wooden toothpick F fused to invention in the periphery of end A, FIG. 3 also shows invention adorned with a sticker tag in the periphery of inventions end B.

FIG. 4 is an isometric top view of my invention in a modified form. The tooth picking portion of the modified form shown as FIG. 4, is more elongated than that of the preferred embodiments end A, same invention with same means having only slight differences in the shape of invention as a whole. FIG. 4 further has instead of a break open end B, a removable tapered stopper. The stopper is tapered and much like that of a wine bottles sealing means, said stopper, capping and sealing open end of inventions centralized and tubular storage compartment.

FIG. 5 is an isometric side view of invention displaying its end B broken open and still partially attached in the periphery of relief cut D by a small untorn section of its side wall in the periphery of inventions relief cut D, opposite side of where breaking pressure is applied. The inventions architecture provides such untorn hinged section automatically in its surface area opposite end of where pressure is applied due to the fact that the relief cut D's depth is only partial with the intent of providing a tearing path for end B to follow upon its initial breaking, following said path and leaving shown arrangement upon the breaking open of invention. Spice dispensing means achieved after a sideways force is applied to inventions side walls in the periphery of end B, leaving said un torn section of its side walls still partially attached and thus the entire break open able end B. FIG. 5 is displayed without sticker tag.

FIG. 6 shows a right side view of the invention after it has been broken open and its spice dispensed. This figure further illustrates that when the invention is integrated with a sticker tag, the tag itself will not interfere with the dispersion of inventions contents.

FIG. 7 is an elevated isometric view of the same.

FIG. 8 of the several drawings shows the invention with modified sticker tag E2 before it is folded back for its placement upon a drinking containers rim.

The sticker tag is shown with its placement under the breakable relief cut where it will not interfere with the inventions utility of being a toothpick or spice dispenser yet providing a good placement for its anchoring means when invention utilizes said tag to attach the invention to a beverage containers rim once tag E2 is folded back into its utilitarian position.

FIG. 9.is an isometric side view of the invention integrated with tag E2 before folding and placing of tag E2 upon a beverage containers rim.

FIG. 10 is an elevated isometric view of invention being utilized as a serving apparatus with a straight serving of tequila. FIG. 10 further shows the proper use of my invention when it is delivered with a straight shot of tequila.

FIG. 11 is an isometric view of invention being utilized as a tooth pick, showing its picking end approaching the crevasses between a persons teeth and gums.

FIG. 12 is an isometric view of my invention equipped with an additional cavity in its food stabbing end which comprises a breakable, sealed, glass capsule containing a luminescent chemical reactant which is surrounded in same additional cavity by a luminescent causing chemical. These two chemicals react to one another causing said luminosity when mixed together by the breaking of said glass capsule upon the bending of inventions architecture in the periphery of said capsule and cavity, causing a breaking of said capsule by said bending and hence forth, a mixing of the two chemicals comprised within said additional cavity of invention. The cylindrical divider shown in the middle of inventions central portion has the utility of separating the contained capsule and its surrounding chemical from the spice containment and dispersal portion of my invention so no cross contamination between the three will occur during both the storage and use of my invention.

FIG. 13 is an isometric view of invention equipped with luminous feature showing where bending and breaking of the invention and glass capsule occurs.

### MODE OF OPERATION

The preferred method of use for my invention in the delivery and consumption of a straight serving of tequila is as follows;

First my invention is taken out of its package which would contain a bulk amount of its embodiments and be stored ideally in the periphery of a service bar where drinks are prepared. Secondly, my invention would be stabbed into a pre sliced pile of lemons or limes as is commonly already available in most bars, stabbing a single piece out of said pile with inventions elongated and tapered end, retaining said piece of fruit in either the middle of inventions elongated structure or nearer the tapered end of inventions elongated structure. My invention, with its newly attached piece of fruit, is then set into the inside periphery of a glass containing a single or double shot of straight tequila. The elongated end B of my invention, might possibly rest its end B partially against the inside wall of the beverage glass's rim, possibly at a angle and dependent on the measurable distance between the beverage glasses opposing side walls, the overall length of invention from end to end, and the size of the single piece of fruit and its placement along the elongated architecture of the invention.

The invention, which should now be resting in at least a semi longitudinal stance within the inside periphery of beverage glass making contact with both the fruit and the tequila with its break open able end facing upward and its elongated tapered end facing downward, providing speedier means of retrieval of both the fruit and the invention by the consumer grabbing the invention with their fingers and lifting said invention and its newly attached compliment by inventions sidewalls in the periphery of its sealed, upward facing, break open able end B. After the consumer lifts the invention and its connected piece of fruit from out of the inside periphery of said drinking glass, he or she can easily, while lemon or lime is still attached, drip a bit of lemon juice or tequila from the retrieved device onto the back portion of the their free hand, in area between the index finger and the thumb for the later addition of poured or sprinkled salt in same area. A partial dissolving and combining of the granular salt substance with the applied moisture dripped from the invention or its attached fruit stops the salt from rolling or falling off of the persons hand prior to it being licked off by the consumer of the tequila. After moisture has been applied to one of the operators hands by either licking or by the dripping of fruit juice onto the hand, the innovative break open able end of invention can be snapped and partially broken open and the salt can be dispensed to the hand of the consumer in the specified region or poured directly on the tongue of the consumer prior to drinking the tequila and eating the lemon or lime, the lemon or lime being separated from the invention by hand prior to its consumption. After final consumption of the salt, the tequila, and the delivered article of fruit, the invention is to be utilized as a toothpick, for the purpose of removing fruit pulp that might be wedged between the consumers teeth and gums. After invention has been utilized as a tooth picking apparatus it is then disposed of in either an ash tray or left on the bar top or table top for the waitress or server to bus at a later time.

The preferred method of use for my invention if used as a food stabbing spice or flavorings delivery means with an article of food other than a fruit slice or wedge:

This invention can contain a variety of different spices and flavors such as ground peppers, salts, seasonings, or even breath freshener. It would be ideal for stabbing into a cucumber sandwich, a juicy steak, a mashed potato or any article of food which is enjoyed with such flavorings. It offers more immediate and recognizable presentation of its flavorings while consecutively offering itself as an apparatus which can clean between a persons teeth. This invention can further be integrated with a chemical luminescent feature which would give off a specific glowing light color for the distinction of certain articles of food delivered to a customer or group of customers. For example, two people sit down and order a filet men yon, one customer wants theirs cooked rare and the other wants their steak cooked medium rare. The two separate cooking's of the two steaks would be more readily identifiable if one had my invention equipped with a red luminescent for indicating to the server or wait staff that the steak was rare and possibly the other steak might have a blue luminescent indicator indicating that it was medium rare. My invention would be stabbed into the steak by the chef prior to it going out to the restaurant and would eliminate any confusion as to which steak was cooked in what manner. In the case of using my invention with an order of steak at a restaurant it might be loaded with a spice which complimented the steak. The same luminescent feature of my invention could even further identify the difference between a diet beverage or non diet beverage or even a non alcoholic beverage from an alcoholic beverage. In the case of my invention being used in this manner it would be activated by the bartender or drink server prior to the beverages delivery to the customer.

The preferred dimensions and materials of my new invention are as follows.

The preferred length of my invention is approximately 4″ to 6″. The preferred width of my invention is approximately ¼″ in diameter from outer side wall to outer side wall, tapering in and forming a solid point shown as end A in the several drawings, taper starting approximately ¾″ away from end A and continuing to a sealed point at end A, forming inventions stabbing and tooth picking portion. The preferred side wall thickness of my invention is approximately 1/16^{th} ″ and is made from plastic material. The preferred plastic material to be used is the same as is used by many ball point pens ink container tubes. All of my prototypes for this invention have been made from this material after flushing its ink out and cleaning the tubing with concentrated cleansing liquid. I find this type of plastic material most suitable due to its structural strength and ease of reforming and adhering to itself after it is heated to a pliable, liquid, state. Also, this material reduces the possibility of my invention snapping into two separate objects after it is broken open by the user.

This plastic is not extremely rigid compared to other plastics which might, because of their hard tensile strength, snap completely into two separate objects upon initial opening of inventions spice storage area and make impossible the inventions utilitarian structure and means of providing a connecting, living, soft pliable hinge after its initial breaking and furthermore, a harder plastic might completely resist the creation of a living hinge upon the breaking open of invention and cause a completely dismantling break, dismantling its unitary structure into two separate objects or masses. This would be undesirable due to the fact that one of this inventions object is to stay together for easier disposal of its used structure as well as inhibiting the chance of a small broken off pieces of its structure ending up in an undesirable or hard to locate area.

### BRIEF DESCRIPTION OF THE DRAWINGS

FIG. 1 is an isometric side view of inventions preferred embodiment void of its sticker tag.

FIG. 2 is a front isometric view of inventions preferred embodiment integrated and dressed with a sticker tag.

FIG. 3. Is an isometric view of a modified from of invention showing two separate materials being combined to form one single integral embodiment, E representing an attached sticker tag.

FIG. 4 is an isometric view of an additional modified form exhibiting a removable, reseal able end, figure further showing a slight modification to the scaling and overall angle of its picking and piercing end as well as a modified positioning of tag E.

FIG. 5 is an isometric side view of invention after it has been snapped open, snapped portion still partially suspended and attached by a living hinge which remains partially in tacked after initial opening of apparatus.

FIG. 6 is a side view of invention after it has been opened showing that the sticker tag will not interfere with the dispersion of the inventions contents after the invention has been snapped open.

FIG. 7 is an isometric view of same.

FIG. 8 is an isometric view of the same preferred embodiment of FIG. 1 with the addition of sticker tag E2, a modified form of sticker tag E. Said sticker tag comprising two cut out portions for partially stabilizing and supporting the invention upon a containers rim after tag E2's two opposing sides have been folded back into a dual hook formation and partially snuggled over said containers rim.

FIG. 9 is an isometric, elevated view of the invention comprising foldable tag E2 before tag E2 is folded into its utilitarian arrangement.

FIG. 10 is an isometric view showing invention after tag E2 has been folded into its utilitarian position and invention has been placed upon a beverage containers rim, invention concurrently piercing a wedge of fruit.

FIG. 11 is an isometric view of invention being utilized as a tooth pick, showing its picking end approaching the crevasses between a persons teeth and gums.

FIG. 12 is an isometric view of my invention equipped with a chemical luminescent feature.

FIG. 13 is an isometric view of my invention showing the bending, breaking, and activation of its chemical luminosity feature.

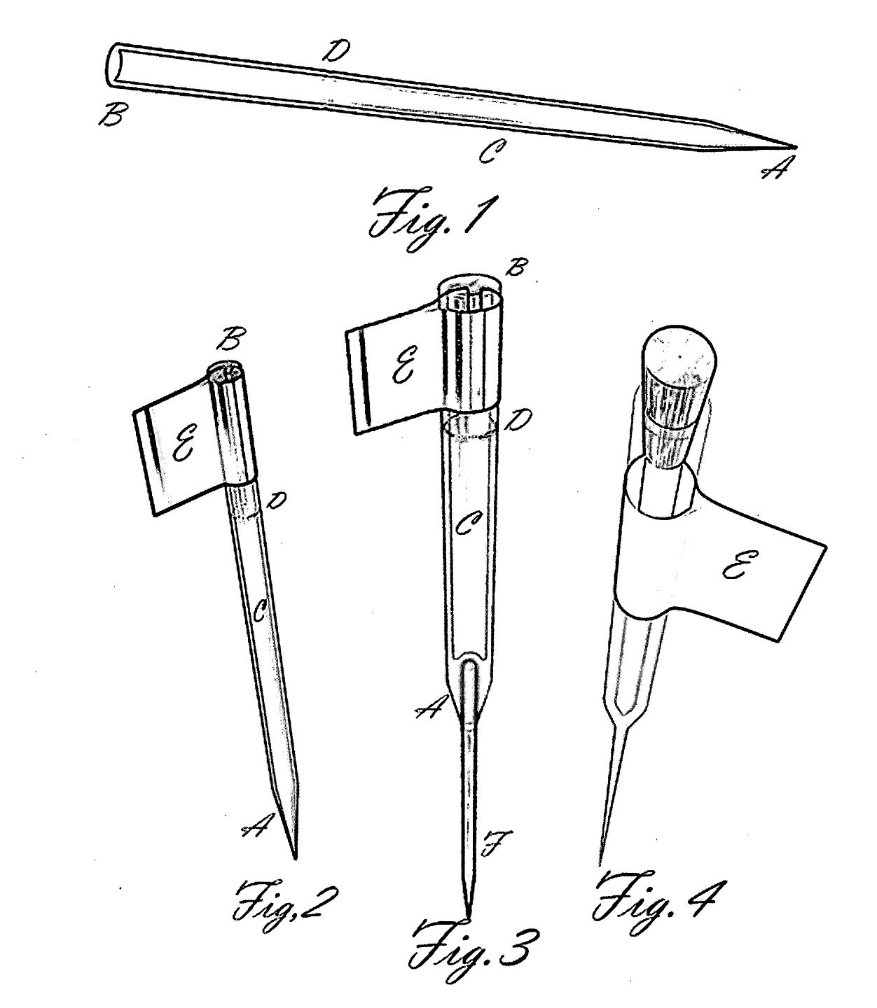

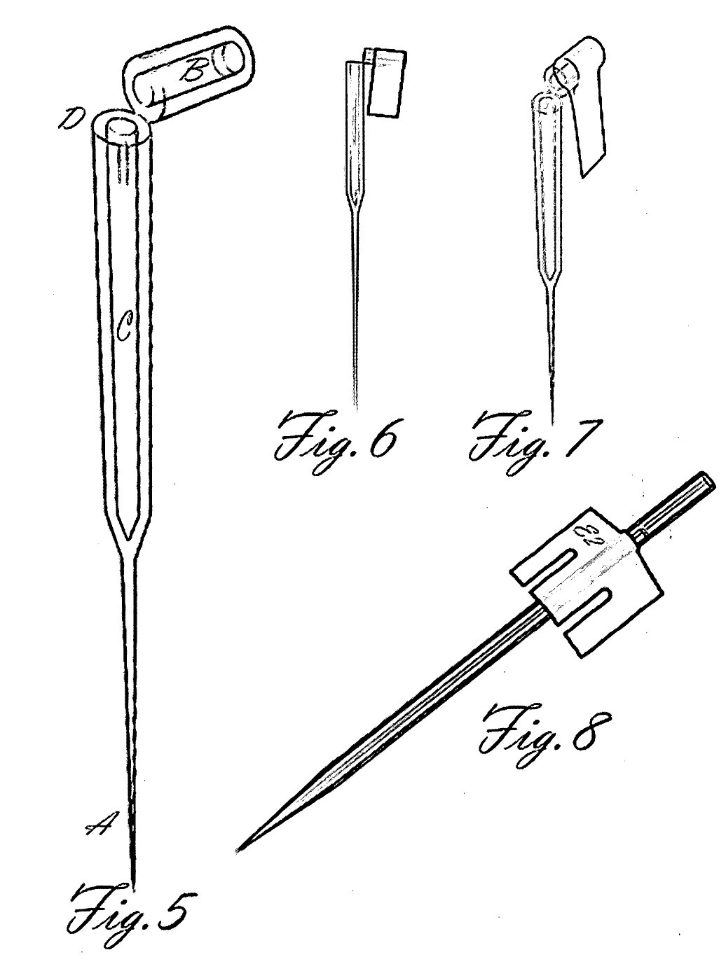

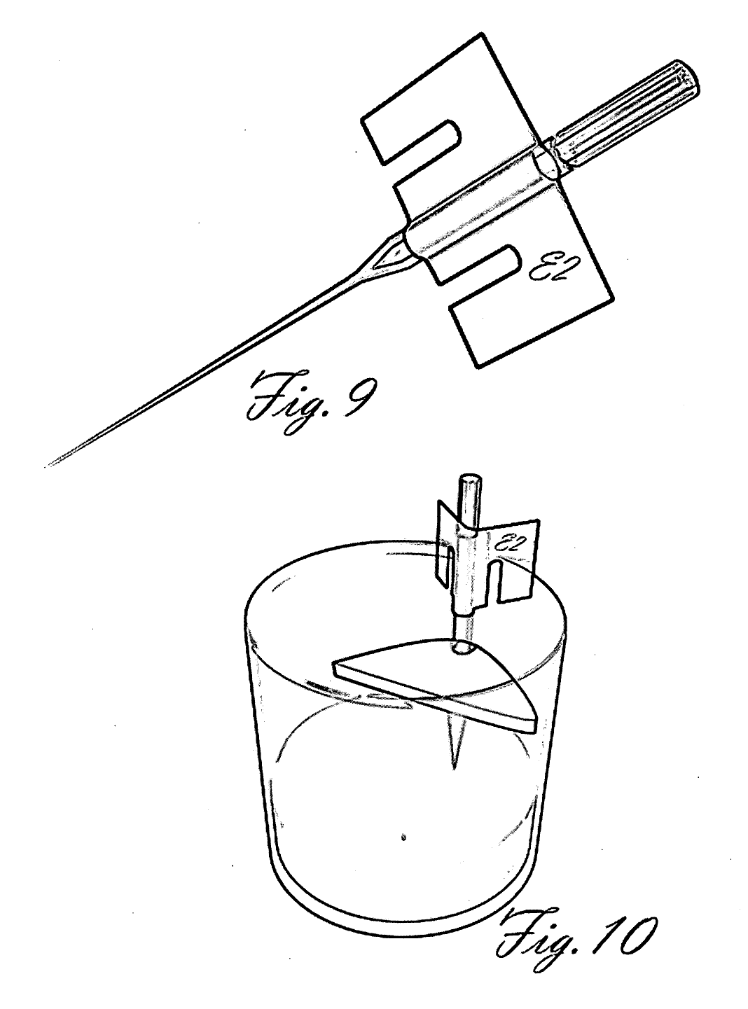

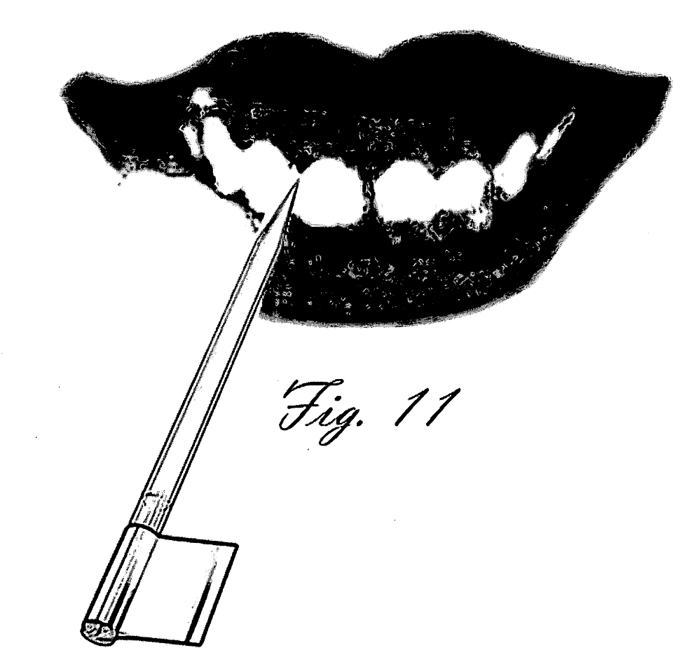

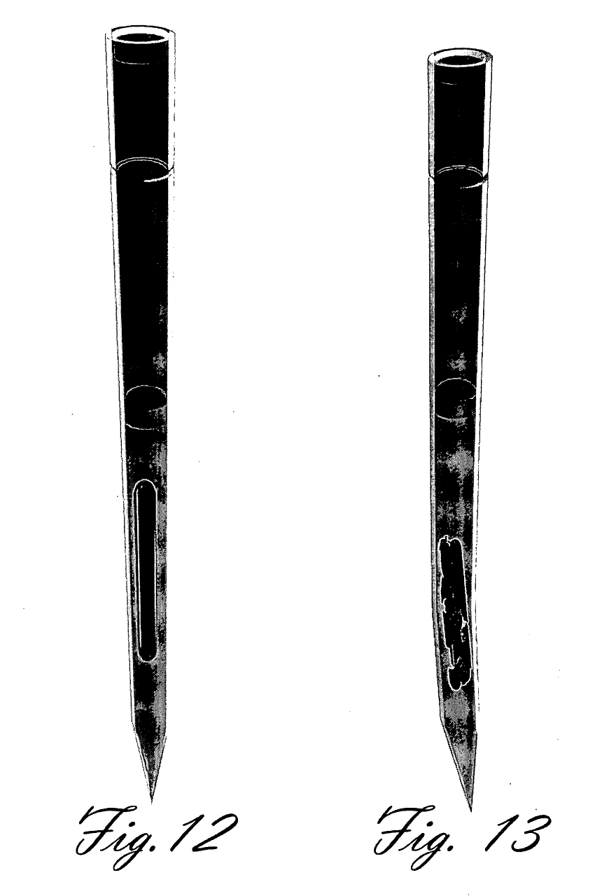

1. What is claimed is an elongated shelled and sealed tooth picking , fruit slice retrieving, substance storage and dispersal apparatus comprising a new, integral, compact, disposable, snap open, spice storage and dispensing structure with food stabbing delivery means to be utilized in the preparation and consumption of a straight serving of tequila as well as other beverages and articles of food which are enjoyed with additional, additive spices and accompaniments.

2. The invention of claim 1 is stabbed into an article of food prior to it being delivered and served, providing speedier accessibility and handle ability as a substance dispensing device, said device broken open by sideways force and friction being applied to its sidewalls in the-periphery of a preformed and structurally pre weakened area, providing speedier access to said apparatuses stored and dispensable substance as well as improved ergonomic handle ability in the opening and dispensing of said stored contents from said device by its operator.

3. The invention of claim 1 aids in the delivery and presentation of an edible spice or flavoring with a beverage or article of food providing more readily available, sanitary access to said spice or flavoring used to flavor said food while further offering more immediate means of removing any excess food from between the teeth and gums of the consumer of said food after said consumer has finished chewing and ingesting their served food by utilizing inventions elongated and tapered point which is integral to inventions architecture.

4. The invention of claim 1 may further comprise an attachable, foldable, dual channel cut, metal, plastic or paper tag, foldable by operator, having the utility of partially enveloping the side walls of a beverage container in the periphery of its rim, partially stabilizing and supporting the device of claim 1 and keeping said device from being completely submerged in the periphery of its gripping end while mounted on a rim comprising an unusually large radius.

5. The invention of claim one further exhibits hand able means for easy removal of said device from the inside periphery of a beverage container by the gripping and lifting of said device out of the inside periphery of said container near its spice dispensing, break open able end.

6. The invention of claim one utilizes its elongated and narrow structure for the spearing of a wedge of fruit and further provides a grip able portion which aids in the removal of said fruit from the inside periphery of a beverage container containing a single straight serving of alcohol and also aids in the removal of invention as a whole which does contain granular spice or flavoring to be enjoyed with said alcoholic beverage.

7. The invention of claim one is structurally designed to be completely water resistant and completely sealed until it is broken open by its operator, inhibiting the mixing of its contained substance with any food juice, liquid beverage, or outside fluid based substance.

8. The invention of claim one provides a more compact means for a multiple utility device, multiple utility being a), a quickly accessible, granular or ground flavoring delivery, retrieval, and dispersal apparatus and means, b), a fruit wedge or slice delivery and retrieval means and apparatus and c), a quick access oral hygiene maintenance device, in a single, all in one, disposable, water resistant, sealed and integral apparatus.

9. The invention of claim 1 may also be constructed by a joining of centrally hollowed out plastic stock material, having surrounding side walls with at least two seal able ends, to a pre fabricated toothpick constructed from a separate material, sealed with glue or heated plastic material to said toothpick forming an integral unit with the utilities claimed in claims 1-10.

10. The invention of claim 1 may also be constructed from a single, plastic, tube stock which is heated to a pliable state and partially reformed to form the structural embodiment and apparatus of claim 1.

11. The invention of claim one may further be constructed from ejection molded plastic techniques, filled with edible spice or flavoring by mechanical actuators or solenoids, and then sealed closed by heat sealing and mechanical pressing of its filling ends side walls together.

12. The break open means of the invention of claim 1 is a structure weakening, breakable, relief cut allowing an easy snapping open of its shelled structure which may also be formed by partially melting the inventions side walls down to a partial depth, in a narrow band comparable in width to the thickness of a score made with a utility knife, by a heated thin metal apparatus rather than forming said weakening relief cut with a metal blade or by forming said breakable relief area in a plastic injection mold process prior to mass production by plastic injection molding techniques.

13. The invention of claim 1 is structurally equipped with a breakable portion which enables partial breakage and opening of its shelled compartment by applied sideways force and friction being applied to its elongated side walls by the operators thumb and fingers in the periphery of its substance dispensing area.

14. The breakable portion of claim 13 retains a connection to inventions elongated architecture by a flexible hinge after invention is broken open by its integral breakable architecture which is made possible by a partially cylindrical relief score in inventions side walls with the utility of partially weakening the structural integrity of inventions side walls in the periphery of its open able end so break open able ends side walls rigidness and thickness can overcome said weakened area and allow a separation and tearing open of said area when said sideways force of claim 13 is applied by the operator while concurrently opening inventions compartment and leaving, opposite side of where breaking pressure was applied, a flexible, connecting hinge of unbroken side wall material.

15. The flexible connecting hinge of claim 14 benefits the disposer of invention by retaining the inventions structure as one single, integral object rather than two separate objects after said invention has been broken open, used to its full utility, and placed on a table or bar top surface area for its later removal and disposal by a wait staff or bartender.

16. A combination food stabbing, tooth picking apparatus comprising substance storage and dispensing means integrally, said device is structurally hollowed out throughout its elongated tooth picking, food stabbing embodiment, having two opposing ends of which one is structurally shaped into an elongated, tapered point, while opposite end is structurally integrated with a sealed, yet break open able, substance dispersal end, forming a substance dispersing spout upon breaking of said device between both of its ends with the aid of a partially circular and surrounding, weakening, relief cut, in devices elongated side walls near its break open able, substance dispersing end.

17. The invention of claim 14 is a device providing substance storage ability and improved ergonmic substance exit means from its elongated structure opposite end of its food stabbing and tooth picking end, said improved ergonomic means provided by inventions new structural improvements which provide added benefit in the speedier and easier opening of its substance storage and delivery means by the addition of a structure weakening break and tear path which partially encircles said devices sidewalls in the periphery of said devices dispersing end, allowing a quick snapping open of said devices substance storage area by operators fingers and thumb while consecutively forming a substance dispersal spout upon said breaking and opening of said device.

18. A method of use for the invention of claims 1-13 being the stabbing of said device into an article of food to be delivered and consumed by a consumer, as where said device, is stabbed into an article of food, prior to it being delivered, providing speedier retrieval of said device and its contents from said foods surface periphery, said device removed by said consumer grasping and lifting said device from said foods surface periphery, said devices stored substance dispersed from said food stabbing device after applied sideways biomechanical force and pressure has been applied to its elongated side walls in the periphery of its pre-weakened relief cut, said device then tilted, by hand, with its dispersal end positioned in a downward slope, said device then tapped by the operators fingers, dispersing said substance onto a desired location by said consumer, said device then utilized as a tooth picking apparatus for the removal of lodged food from between the consumers teeth and gums after said consumer has consumed said food, said tooth picking utility followed by the disposal of said food stabbing apparatus after it has been used as a toothpick, food stabber, and substance delivery and dispersal device.

19. The apparatus of claim one may further comprise an additional sealed cavity within its shelled housing which would contain two separate chemicals, one chemical being sealed within a breakable glass capsule with the other liquid chemical surrounding said capsule within said additional cavity and mixable together upon the partial bending of inventions elongated structure, simultaneously breaking said capsule for the mixing together of the two chemicals within the periphery of said additional cavity and causing a luminescent reaction within the apparatus of claim 1 prior to its delivery to the consumer with the purpose of color coding for beverage or food article distinction.

20. The apparatus of claims 1 and 14 may use removable ribbon tape for the sealing of its flavoring containment and dispensing portion, removable by hand by peeling said ribbon tape away from said dispensing area, revealing a hole or exit area in its shelled storage compartment for the allowed passage of ground spice or flavoring through said hole after said tape has been peeled away from the predetermined dispensing area of the invention of claim 1, preferably at the opposite end of inventions pointed food stabbing periphery and shown in the several drawings as end B.
